(19) United States
(12) Patent Application Publication
(10) Pub. No.: US 2022/0270126 A1
(43) Pub. Date: Aug. 25, 2022

(54) Reinforcement Learning Method For Incentive Policy Based On Historic Data Trajectory Construction

(71) Applicant: BEIJING DIDI INFINITY TECHNOLOGY AND DEVELOPMENT CO., LTD, Beijing (CN)

(72) Inventors: Weiyang Qu, Mountain View, CA (US); Qingyang Li, Mountain View, CA (US); Zhiwei Qin, Mountain View, CA (US); Yiping Meng, Mountain View, CA (US); Yang Yu, Mountain View, CA (US); Jieping Ye, Mountain View, CA (US)

(21) Appl. No.: 17/618,863

(22) PCT Filed: Jun. 14, 2019
(86) PCT No.: PCT/CN2019/091247

§ 371 Date: Dec. 13, 2021

(51) Int. Cl. G06Q 30/02

(52) U.S. Cl. CPC G06Q 30/0226

(57) ABSTRACT

A system and method to optimize the distribution of incentives for a transportation hailing service is disclosed. A database stores state data and action data received from a client devices and transportation devices. The state data is associated with the utilization of the transportation hailing service and the action data is associated with different incentives to passengers to engage the transportation hailing service. A Q-value determination engine is trained to determine rewards associated with incentive actions from a set of virtual trajectories of states, incentive actions, and rewards, based on a history of the action data and associated state data from the database. Passengers are ordered according to V-values. An incentive policy including selected incentive actions based on the determined rewards and passengers is created. An incentive server communicates selected incentives to at least some of the client devices according to the determined incentive policy.

### FIELD

This application relates to transportation services. In particular, the application is directed toward a system to optimize incentive policies for maximizing rewards for using a transportation hailing service.

### BACKGROUND

Recently transportation hailing systems based on a model of matching drivers with passengers via electronic devices have become widespread. Transportation hailing services depend on attracting passengers and retaining drivers. Thus, transportation hailing companies have set up systems to track passengers. Such companies find it advantageous to predict passenger patterns and therefore formulate targeted marketing for such passengers to increase service to such passengers. In order to retain passenger loyalty, transportation hailing companies often send coupons to preferred passengers that allow discounts from fares paid by the customer over the company platform.

Such transportation hailing companies often base marketing strategies around such coupons that are made available to passengers via mechanisms such as sending text messages to personal electronic devices such as smart phones. Such companies have found it desirable to refine marketing strategies of when to distribute coupons, to which passengers, and in what amounts, via an analysis system.

Thus, it is desirable to provide an intelligent marketing system, that applies Artificial Intelligence (AI), Machine Learning (ML), Reinforcement Learning (RL) and other analysis tools to analyze and process a dataset related to high-volume passengers of a transportation hailing system. It would be desirable for a system to track the state of users of the system and provide intelligent allocation of marketing budgets and forecasting profit, so as to achieve maximum return on investment marketing by attracting more drivers and passengers into the shared transportation system. A long-term goal is to provide automatic, intelligent, and personalized maintenance of each driver and passenger, so as to maximize the LTV (Life Time Value) of all the drivers and passengers.

On the passenger side, it would be desirable for a platform that intelligently guides and motivates passengers to maximize life time value (LTV) on the platform through various operational grips such as coupons or other incentives. It would be desirable to establish an intelligent incentive system that automatically tracks the life cycle and current status of each passenger, and automatically configures various operations according to various operational objectives to maximize the life time value (LTV) of passengers on the transportation hailing system.

One method is a reinforcement learning method to determine an optimal strategy or policy for sending coupons to passengers for the purpose of maximizing rewards. Such a learning method is currently based on historical data of passenger interaction with the transportation hailing system. The challenge in a reinforcement learning policy update is how to evaluate the current strategy for issuing coupons to passengers. Since the policy is not implemented in historical data, it is difficult to directly update and evaluate the policy directly with historical trajectories. The focus of the problem thus is how to determine a virtual trajectory generated by the current policy to provide a better passenger incentive strategy.

### SUMMARY

One example disclosed is a transportation hailing system. The system includes a plurality of client devices. Each of the client devices are in communication with a network and execute an application to request a transportation hailing service. Each of the client devices are associated with one of a plurality of passengers. The system includes a plurality of transportation devices. Each of the transportation devices execute an application displaying information to provide transportation to respond to a request for the transportation hailing service. A database stores state data and action data received from the plurality of client devices and the plurality of transportation devices. The state data is associated with the utilization of the transportation hailing service and the action data is associated with a plurality of incentive actions for each passenger. Each incentive action is associated with a different incentive to a passenger to engage the transportation hailing service. An incentive system is coupled to the plurality of transportation devices and client devices via the network. The incentive system includes a Q-value neural network trained to determine rewards associated with incentive actions from a set of virtual trajectories of states, incentive actions, and rewards, based on a history of the action data and associated state data. The incentive system includes a V-value neural network operable to determine a V-value from the use of the transportation service for each of the plurality of passengers. The V-value is determined by an incentive policy engine operable to order the plurality of passengers according to the associated V-values and determine an incentive policy including selected incentive actions from the plurality of incentive actions based on the determined rewards for each of the plurality of passengers. An incentive server is operable to communicate a selected incentive to at least some of the client devices according to the determined incentive policy via the network.

Another example is a method of determining the distribution of incentives to use a transportation hailing system. The transportation hailing system includes a plurality of client devices. Each of the client devices is in communication with a network and executes an application to request a transportation hailing service. Each of the client devices are associated with one of a plurality of passengers. The transportation hailing services includes a plurality of transportation devices. Each of the transportation devices execute an application displaying information to provide transportation to respond to a request for the transportation hailing service. State data and action data received from the plurality of client devices and the plurality of transportation devices are stored for each passenger in a database. The state data is associated with the utilization of the transportation hailing service and the action data is associated with a plurality of incentive actions. Each incentive action is associated with a different incentive to a passenger to engage the transportation hailing service. A Q-value neural network is trained to determine rewards associated with actions from a set of virtual trajectories of states, incentive actions, and rewards, based on a history of the action data and associated state data from the database. A V-value is determined from the use of the transportation service for each of the plurality of passengers via a V-value neural network. The plurality of passengers is ordered according to the associated V-values via an incentive policy engine. An incentive policy including selected incentive actions from the plurality of incentive actions is determined based on the determined rewards via the incentive policy engine. A selected incentive is communicated to at least some of the client devices via an incentive server according to the determined incentive policy.

Another example is an incentive distribution system including a database storing state data and action data received from a plurality of client devices and a plurality of transportation devices. The state data is associated with the utilization of a transportation hailing service by a plurality of passengers associated with one of the client devices. The action data is associated with a plurality of incentive actions. Each incentive action is associated with a different incentive to a passenger to engage the transportation hailing service. The incentive determination system includes a Q-value determination engine that is trained to determine rewards associated with incentive actions from a set of virtual trajectories of states, incentive actions, and rewards, based on a history of the action data and associated state data from the database. The incentive determination system includes a V-value engine operable to determine a V-value from the use of the transportation service for each of the plurality of passengers. The incentive determination system includes an incentive policy determination engine that is operable to order the plurality of passengers according to the associated V-values; and determine an incentive policy including selected incentive actions from the plurality of incentive actions based on the determined rewards for each of the plurality of passengers. The incentive determination system also includes an incentive server, operable to communicate a selected incentive to at least some of the client devices according to the determined incentive policy.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

Embodiments are illustrated by way of example and not limitation in the figures of the accompanying drawings, in which like references indicate similar elements and in which:

FIG. 1 illustrates a block diagram of a transportation hailing environment that includes intelligent distribution of incentives among passengers to maximize reward;

FIG. 2 illustrates a block diagram of an intelligent engine to determine the optimal strategy to distribute coupons for maximum value;

FIG. 3 illustrates a flow diagram of the process to determine optimal strategy to distribute coupons for maximum value;

FIG. 4 illustrates a flow diagram of the routine for training an intelligent Q-value engine to determine the reward for a particular incentive action;

FIG. 5 illustrates a flow diagram of the breaking up of historical datasets for the learning process of transition functions for determining next states;

FIG. 6 illustrates a flow diagram for obtaining a virtual trajectory based on historical data;

FIG. 7 illustrates a flow diagram for the overall process of obtaining an updated incentive policy;

FIG. 8 illustrates a flow diagram of the routine to issue incentives according to the updated incentive policy;

FIG. 9 illustrates a table showing the results of an experiment performed using strategies determined by the example incentive determination system for determining a policy for incentivizing passengers; and

FIG. 10 illustrates a block diagram of an exemplary computer system in which any of the embodiments described herein may be implemented.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION

Embodiments of the transportation-hailing platform, such as a car-hailing platform, and related methods are configured to generate a policy to optimize incentives for attracting passengers to increase rewards for the transportation hailing system.

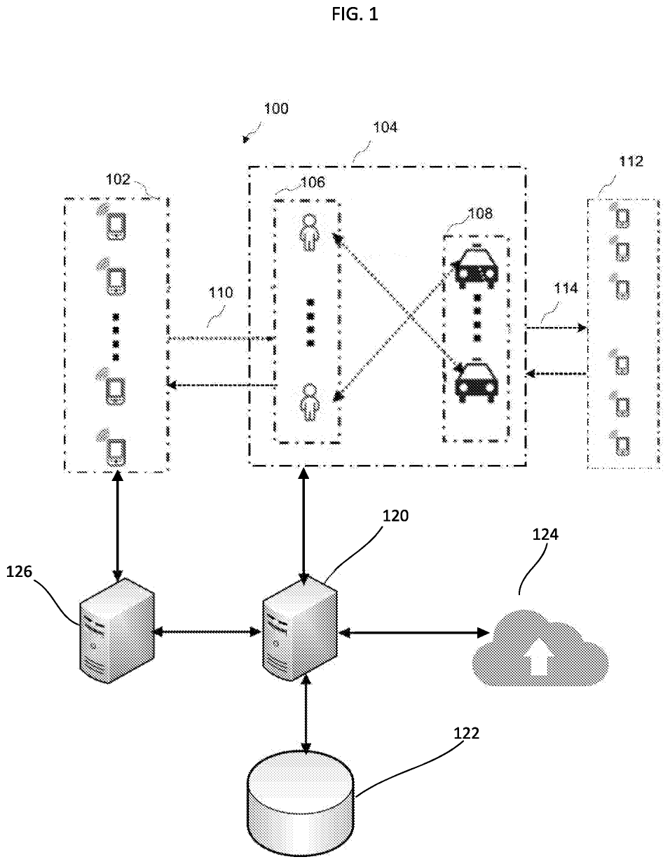

FIG. 1 illustrates a block diagram of a transportation hailing platform 100 according to an embodiment. The example transportation hailing platform 100 includes client devices 102 configured to communicate with a dispatch system 104 via a communication network 110. The dispatch system 104 is configured to generate an order list 106 and a driver list 108 based on information received from one or more client devices 102 and information received from one or more transportation devices 112. Typically, the transportation devices 112 are carried by drivers of transportation such as automobiles. The transportation devices 112 are digital devices that are configured to receive information from the dispatch system 104 and transmit information through a communication network 114. For some embodiments, communication network 110 and communication network 114 are the same network such as the Internet. The one or more transportation devices 112 are configured to transmit location information, acceptance of an order, and other information to the dispatch system 104. For some embodiments, the transportation device 112 transmission and receipt of information is automated, for example by using telemetry techniques. For other embodiments, at least some of the transmission and receipt of information is initiated by a driver.

The dispatch system 104 is configured to generate a price for transportation from an origin to a destination, for example in response to receiving a request from a client device 102. For some embodiments, the request is one or more data packets generated at the client device 102. The data packet includes, according to some embodiments, origin information, destination information, and a unique identifier. For some embodiments, the client device 102 generates a request in response to receiving input from a user or passenger, for example from an application running on the client device 102. For some embodiments, origin information is generated by an application based on location information received from the client device 102. The origin information is generated from information including, but not limited to, longitude and latitude coordinates (e.g., those received from a global navigation system), a cell tower, a wi-fi access point, network device and wireless transmitter having a known location. For some embodiments, the origin information is generated based on information, such as address information, input by a user into the client device 102. Destination information, for some embodiments, is input to a client device 102 by a user. For some embodiments, the dispatch system 104 is configured to request origin, destination, or other information in response to receiving a request for a price from a client device 102. Further, the request for information can occur using one or more request for information transmitted from the dispatch system 104 to a client device 102. The dispatch system 104 also serves to accept payments from the client devices 102 for the provided transportation hailing services in contacting one of the transportation devices 112 carried by drivers.

The dispatch system 104 is configured to generate a quote based on a pricing strategy. A pricing strategy is based on two components: 1) a base price which is a fixed price relating to the travel distance, travel time, and other cost factors related to meeting the request for transportation; and 2) a pricing factor which is a multipli-cation over the base price. In this example, the pricing strategy is configured to take into account future effects. For example, the pricing strategy is configured to encourage requests (for example, by a decreased price) that transport a passenger from an area of less demand than supply of transportation and/or pricing power (referred to herein as a “cold area”) to an area that has greater demand than supply of transportation and/or pricing power (referred to herein as a “hot area”). This helps to transform the requests from a passenger having an origin in a cold area into an order, that is a passenger that accepts the price quote for the transportation to a destination in a hot area. As another example, the dispatch system 104 is configured to generate a pricing strategy that discourages an order (for example, by a reasonably increased price) for a request for transportation from hot areas to cold areas.

After a driver is assigned to the passenger and drives the passenger to a hot area, the driver is more likely to be able to fulfill another order immediately. This mitigates the supply-demand imbalance, while potentially benefiting both the ride-hailing platform (with increased profit) and the passengers (with decreased waiting time). The future effect of a bubble pricing strategy is reflected from the repositioning of a driver, from the original position at the current time to the destination of the passenger at a future time.

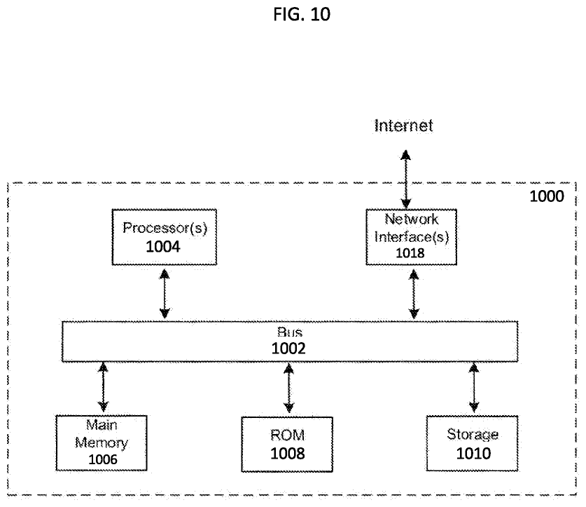

A digital device, such as the client devices 102 and the transportation devices 112, is any device with a processor and memory. In this example, both the client devices 102 and the transportation devices 112 are mobile devices that include an application to exchange relevant information to facilitate transportation hailing with the dispatch system 104. An embodiment of an example digital device is depicted in FIG. 10.

An incentive determination system also allows incentives to engage transportation services to be sent to the client devices 102. The incentive determination system includes a strategy server 120. The strategy server 120 is coupled to a passenger database 122. The passenger database 122 includes passenger background specific data and dynamic passenger usage data. The passenger database 122 receives such data from the strategy server 120. The strategy server 120 derives passenger background data from the client devices 102 and from other sources such as the cloud 124. Thus, other information such as address, gender, income level, etc. may be assembled and data mined by the strategy server 120 to provide a profile for each passenger. The strategy server 120 derives dynamic usage data from the dispatch system 104 to determine summary data of the usage of passengers of the transportation hailing services.

The strategy server 120 is coupled to an incentive server 126 that pushes out different incentives to the client devices 102 via the communication network 110. The incentives in this example are coupons that when redeemed by a passenger result in a reduction in the fee for using the transportation hailing service. The specific passengers and coupon amounts are determined according to the incentive strategy determined by the strategy server 120. In this example, the coupons are discount amounts applied to the prices of rides ordered by passengers from the transportation hailing system 100. The coupons may have a percentage limit of the total value charged for a ride. The coupons may have different limitations such as geographic area, or times that the discount is applied or the amount of the discount. In this example, the coupons are distributed via text messages sent to the client devices 102 via the communication network 110. However, other means may be used to distribute the coupons to passengers such as via emails or other electronic messaging media to the client devices 102 or other digital devices that a passenger may have access to. On receiving the coupon on a client device 102, the passenger may provide an input to the client device 102 to activate the coupon and thus obtain the discount in payments for the transportation hailing service. The coupon may also be activated by the passenger via the transportation hailing application on the client device 102. As explained above, the transportation hailing application will allow a request to be made for the transportation hailing service. The dispatch system 104 will receive the coupon and apply for determining the fee when contacting one of the transportation devices 112. As will be explained below, the strategy server 120 provides a policy for optimal distribution of coupons to the client devices 102 based on virtual trajectories determined from historical trajectory data in order to maximize the rewards from the passengers.

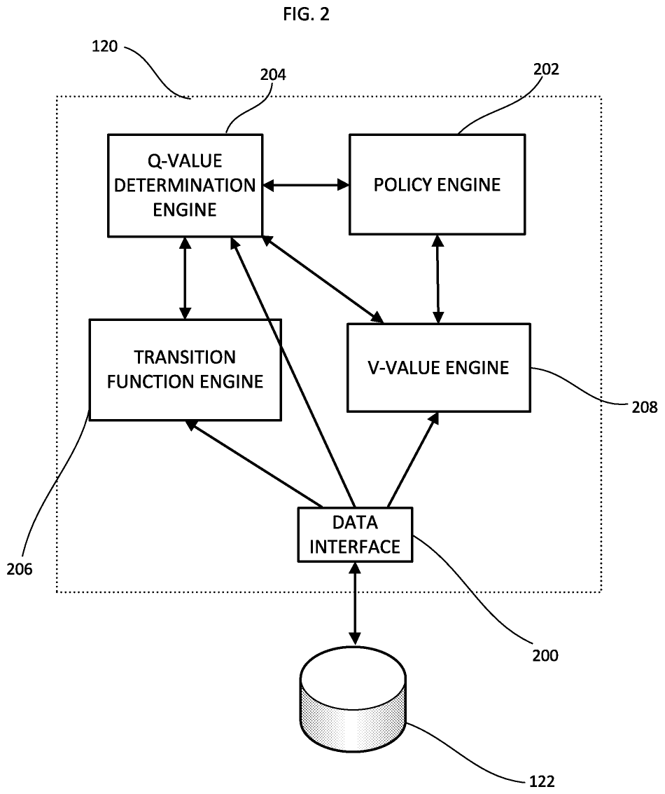

FIG. 2 is a block diagram of the strategy server 120 in FIG. 1. The strategy server 120 includes a database interface 200, a policy engine 202, a Q-value determination engine 204, a transition function engine 206, and a V-value engine 208. As will be explained below, the Q-value determination engine 202 determines Q-values used to evaluate incentive policies. The transition function engine 206 generates transition functions to determine the success of different types of incentives offered to passengers. The V-value engine 208 generates the value of transportation services used by each of the passengers.

In this example, the Q-value determination engine 204, transition function determination engine 206, and the V-Value engine 208 are neural networks. As will be explained, the Q-value determination engine 204, V-value engine 208, and transition function determination engine 206 are trained from historical passenger data in the database 122 and related data derived from the historical passenger data.

The incentive policy engine 202 produces an incentive strategy that determines different types of coupons to be sent to passengers to maximize rewards to the system 100 in this example. The incentive policy engine 202 dynamically updates the incentive strategy as more use data for the passengers in relation to previous incentives is collected.

Each passenger associated with one of the client devices 102 may have a composition of state statistical data. The state statistical data is compiled for each cycle for all passengers. In this example, the cycle is based on one day, but other cycle periods may be used. The state statistical data includes statistical characteristics (including statistical and data-mining features), real-time characteristics (time, weather, location, etc.), geographic information features (traffic conditions, demand conditions, supply conditions) and so on. The state statistical data is gathered from the strategy server 120 and stored in the database 122.

In this example, actions in the incentive strategy include all of the different types of text messages for coupons sent by the incentive server 126 to the client devices 102. Data relating to the text messages are sent to the database 122 by the exact date, sending cost and the type of coupon sent. The type of the coupon can vary by the content of the coupon such as having different discount values. For the passenger rewards in this example, there are two different type of rewards, an intermediate reward and a long-period reward. The long-period reward provides lifetime value to the passenger. The intermediate reward is the payment of a passenger in the finished order on that day. The long-period reward is life time value (LTV) to accumulate the long time value of the passengers.

The demand for rides by passengers may be formulated as a reinforcement learning and Markov Decision Processes (MDP) problem. The problem may be formulated as a potential MDP <S, A, T, R> and a non-optimal policy, [symbol] . S is an observation set of the transportation hailing platform, indicating the state of a passenger, such as the number of orders, the time of completion, the price paid, the destination and pick up locations. A is the action set, which indicates the different incentives offered to passengers for using the transportation hailing platform. For example, the action set A may include different coupon amounts or coupons of varying values depending on time or location. T is the transition function, which determines which state the passenger will move to after the action A is executed from the current state, s. R is the reward function, indicating the amount the passenger paid to the transportation hailing platform in a certain state, s.

**Here the trajectory set of a sample of passengers is D={τ₁, τ₂ . . . τₘ}, where τᵢ=(s₀ⁱ, a₁ⁱ, r₁ⁱ, . . . sₗ_{ᵢ}ⁱ) is a trajectory sequence data for each of the actions, states, transition function, and reward function for each passenger, and lᵢ is the trajectory length. The goal of this technique is to learn incentive policies, π* from the set of trajectories D, so that the transportation hailing platform can receive the largest cumulative rewards in the interaction with passengers. The cumulative awards may be represented by the equation:

J=(π*)=E_{π*}[Σₜ₌₁^{∞}γ^{t-1}rₜ].

In this equation, π* is the optimal policy the model attempts to learn, E is expectation function of the reward for the activity, r is the reward, rₜ is the reward in the t-th step on the whole trajectory, γ^{t-1} is the discount factor. The equation E_{π*}[Σₜ₌₁^{∞}γ^{t-1}rₜ] is therefore provided to maximize the expectation of total summation of rewards of a trajectory by the optimal policy function π*.

The disclosed method for determining an optimal incentive strategy focuses on motivating passengers to use the transportation hailing platform. In order to better motivate passengers to complete transportation orders on the platform, a MDP may be built to model the passengers' incentives problem. Currently available data on passengers from the database 122 include daily status, daily payments, and incentives sent via text messages. The passenger's daily status data, in this example, includes the daily characteristics of the passenger in relation to ride data and data mining characteristics of the passenger, which may be obtained from the client devices 102 or other sources. The daily status data in this example does not contain real-time features. The passenger's daily payments data includes payments received from the passenger for transportation hailing services. The marketing data sent to each passenger is derived from historical data reflecting sent messages with coupons from the incentive server 126 to the client devices 102.

In the reinforcement learning task, for strategy, π, the cumulative reward, J(π) may be stated as:

J(π)=E_{π}[Σₜ₌₁^{∞}γ^{t-1}rₜ],

This may be rewritten as:

J(π)=∫_{τ}p^{π}(τ)R(τ)dτ

where p^{π}(τ)=p(s₀)Πₜ₌₁^{L}π(aₜ|sₜ₋₁)T(sₜ|aₜ, sₜ₋₁) is the probability of trajectory generation, and R(τ) is the cumulative reward in one trajectory, s is the current state, and a is an action such as one of the coupon types that may be sent to the passengers.

If the data set D contains all possible trajectories, then even if D is a static data set, it can be used to evaluate any incentive policy. However, there are only a few trajectories in the data set D from historical data. Because the policy, π, has not been executed in the historical data, it is difficult to update and evaluate the policy π directly with the historical trajectory. Thus, a virtual trajectory set of the current policy, π, is constructed in this example. The virtual trajectory set is then used in evaluating and updating the current strategy, π, through the historical trajectory reorganization method as will be described below.

In this scheme, the inventive policy, π, is represented by the Q-value determination made by the Q-value determination engine 204 in FIG. 2. The Q function, Q(s, a), represents the cumulative expected reward of executing an action, a, under the current state, s. In the issue coupon task which involves determining the amount of the coupon to be issued, the action is discrete. When the Q value determination engine 204 is available, the corresponding Q value for the state, s, for each action, a, may be learned. Thus, the action execution with the largest Q value may be selected to complete the coupon strategy for individual passengers.

After solving the problem of the amount of the coupon for each individual passenger, the next concern is how to select the target passenger population to receive the coupons under a given budget. Here, the method considers the use of people with higher V-values to issue coupons, where the V-value is the sum of the payments of a passenger from the day to the end of a predetermined time period. The V-value function is a value function that is only related to the state, s, which represents the expectation of the reward that the current state, s, can obtain. The larger the V-value, the higher the Gross Merchandise Volume (GMV) that the system can obtain. The V-value is calculated for each passenger via the V-value determination engine 208 in FIG. 2.

After obtaining the V-value from the V-value determination engine 208 in FIG. 2, the policy engine 202 can sort the passengers in the crowd from highest to lowest V values, and then determine the amount of each passenger's issued coupons according to Q-values for each passenger in the Q-value determination engine 204. The incentive server 126 of the system may then issue the coupons to the identified passengers until the budget is consumed.

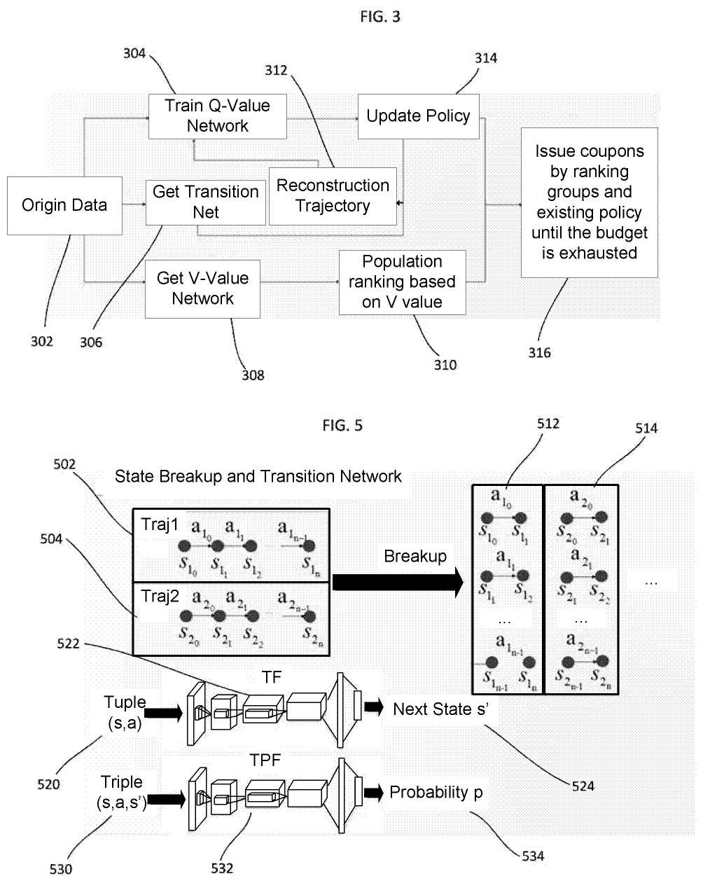

The overall budget allocation process is shown in FIG. 3. First, the incentive determination system accesses the origin data for passengers from the database 122 (302). The system then trains the Q-value determination engine 204 with the origin data (304). The system also accesses the origin data to obtain the transition functions from the transition function engine 206 (306). The origin data is the broken up data from the whole trajectory. The system also accesses the origin data to train the V-Value determination engine 208 (308).

The system ranks the population of passengers based on the respective V-value for each passenger as explained above (310). A reconstruction trajectory is used as another input to train the Q-value determination engine 204 (312). The output of the Q-value determination engine 204 is used to update the overall policy (314). The output of the Q-value determination engine 204 is used to update the incentive policy via the policy engine 202 (314). The policy engine 202 determines the updated policy of issuing coupons to passengers. The updated policy provides an input to the reconstruction trajectory determination (312) and the transition network (306).

After completion of the policy update (314) and the ranking based on V-value (310), the system issues coupons by ranking groups and existing policy until the overall budget for such coupons is exhausted (316). The coupons then may be distributed to passengers via the incentive server 126 in FIG. 1,

The core of the budget allocation framework is how to carry out the policy update process (314) in FIG. 3. In the example incentive issuance task (316), the goal of the strategy is to select the appropriate amount of the coupon for each passenger to maximize the Gross Merchandise Volume (GMV) generated for the transportation hailing system.

Considering that there is a large amount of historical data in relation to passengers in the database 122, the historical trajectory reorganization method is used to reconstruct the trajectory generated by the current policy, π, and then use the newly generated trajectory to evaluate and update the current strategy.

Two modules, the current policy, π, determination engine 202 and the transition function, T, engine 206 are required to obtain the reorganization trajectory in this example. The Q-value determination engine 204 is used to update the incentive policy based on the inputs from the current policy engine 202 and transition function engine 208.

In this example, the Deep Q-Learning Network (DQN) method is used to train and update the Q-value determination engine 204. In this model, the Deep Q-learning network model is trained based on the historical transition data or reconstruction trajectories without building a simulator. This is done by pooling data in the replay buffer and sampling mini-batches.

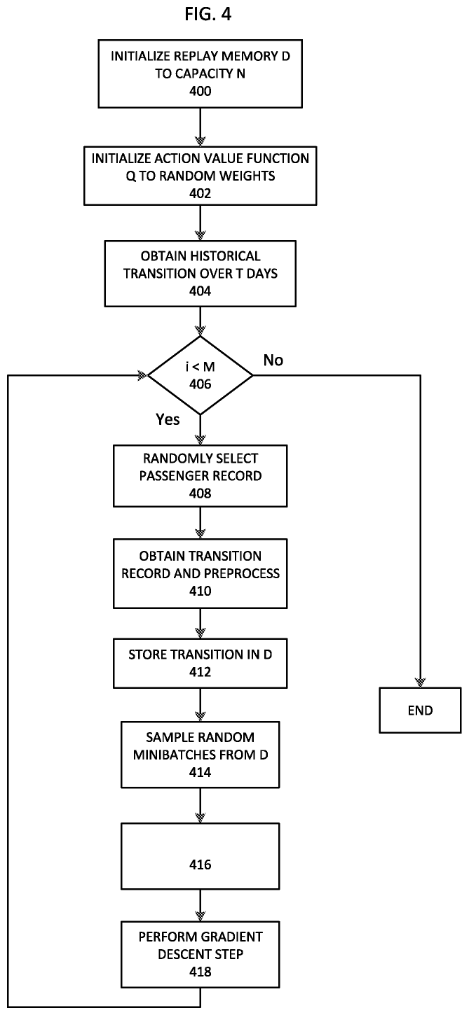

The process of training the Deep Q-learning network of the engine 204 is shown in FIG. 4. The replay memory D is first initialized to capacity N (400). N is the number of records the buffer of the replay memory D can store. The action value function, Q, is initialized with random weights (402). The system then obtains the historical transitions of each passengers over T days: {sₜ, aₜ, γₜ, sₜ₊₁}, where t∈(0, T) (404) The routine then determines whether the analysis has been performed for each episode (1, M) (406). If there are remaining episodes, the routine randomly selects a passenger's record of T days from the transition pool (408). For the time periods between the initial time and the Tth day, the routine obtains the transition record {sₜ, aₜ, γₜ, sₜ₊₁} from the historical record and performs a preprocessing routine ϕₜ₊₁=ϕ (sₜ₊₁) (410). In this example, ϕ represents a function that takes the state, s, as an input and outputs a processed state. The transition (ϕⱼ, aₜ, γₜ, ϕⱼ₊₁) resulting from the preprocess is stored in D (412). The routine then samples random minibatches of transitions (ϕⱼ, aⱼ, γₜ, ϕⱼ₊₁) from D (414). The routine then determines an estimate of the accumulated expected reward (416). The expected reward yⱼ is set to the reward in the transition record, γⱼ for the terminal ϕⱼ₊₁. For the other values, the expected reward, yⱼ, is set as rⱼ+τmax_{a′} (Q (ϕⱼ₊₁, a′; θ). The routine then performs a gradient descent step on (yⱼ−Q(ϕⱼ₊₁, a′; θ))² (418) in order to minimize the function. The routine then loops back to determine whether there is another remaining episode (406).

The transition function (TP) and the transition probability function (TFP) are trained by breaking up the original data and then passing the broken data to supervise the training. The so-called breakup is to transform the original trajectory τ=(s₀, a₁, r₁, . . . , sₙ, rₙ) into a data set U={(sᵢ, aᵢ, rᵢ, s′)}ᵢ₌₁ⁿ⁻¹ the state level. The transition engine 206 in the system learns the two transition models according to the data obtained after breaking up the original data. The first transition model is the transition function, TF, which takes an action state pair as an input and produces the next state, s′, as the target output. The second transition model is the transition probability function, TPF, that directly takes the disbanded triple (s, a, s′) as an input, and outputs whether the triple has appeared in the historical state (1 appeared, 0 did not appear). In this example, s is the current state, a is the action, and s′ is the next state.

Although the data is marked 0 or 1 when training the transition probability function TPF, when the network training is completed in this example, the transition probability function can output a real value of the interval, which indicates the probability of the corresponding triple (s, a, s′) composition.

FIG. 5 shows an example the process of breaking current data, which is used to process the original data fed into the get transition network step 306 in FIG. 3. FIG. 5 shows the process of breaking up the trajectory and thereby train the transition network. FIG. 5 shows an example two initial trajectories 502 and 504 that are obtained from passenger data in the database 122. Each of the trajectories 502 and 504 have corresponding actions and states. The initial trajectories 502 and 504 are each broken up to individual sets of states, actions and subsequent states 512 and 514.

A tuple of each initial state and action provides an input 520 into a transition model, TF 522. The transition function TF model 522 takes the action state pair for each of the broken data as an input 520 and produces a next state, s′, as a target output 524. A triple of each initial state, action and subsequent state provides an input 530 into a transition probability function TPF model 532. The transition probability function TPF model 532 directly takes the disbanded triple state, action and next state (s, a, s′) as the input 530, and produces an output 534 whether the next state, s′, has appeared in from the state, s, (1 appeared, 0 did not appear). As explained above, the output may alternatively be a probability between 1 and 0 of whether the next state, s′ has appeared.

The process of generating a trajectory is starting from the initial state s₀, the policy, π, generates an action aₜ=π(sₜ₋₁), and according to the transition function, T, the next state is sₜ=T(sₜ₋₁, aₜ). Given the input of the current state and action (s, a) and the output of the next state, s′, determined by the transition function, if s′ appears in the historical state, then a one-step trajectory construction is completed. If the s′ output by the transition function is not in the historical state, Sₕᵢₛ, then the output s′ to the historical state set, Sₕᵢₛ, needs to be mapped. One way of mapping is to find the K-nearest neighbor Sₖ={s₁′, s₂′, . . . , sₖ′} of s′ in the historical state set Sₕᵢₛ. ∀sᵢ′∈Sₖ, according to transition probability function TPF, and a historical state with the highest transition probability from Sₖ is picked as the next state, where the next state s*=maxₛ_{_{i′}}TP(s, a, sᵢ′). By executing this method in turn, a complete trajectory may be obtained.

The reward of the triple (s, a, s′) in a particular construction trajectory is determined by this process. Rewards can be discussed in two situations, if the reward has appeared historically, or if it has not. First, if the triple (s, a, s) has appeared in the historical state level dataset, U, that is (s, a, s′)∈U, then the reward r(s, a, s′) can be obtained directly from the historical data. If the triple has appeared many times in the historical dataset, the average of all the rewards is taken as the reward value. If the triple (s, a, s′) has not appeared in the historical state, then the mean reward on state s′, which can be written as E_{(\tilde{s},ã,s′)∈U}r(\tilde{s}, ã, s′) and is set as the reward of r(s, a, s′), where \tilde{s} is the set of states whose next state are s′. If the triple (s, a, s′) does not exist in the historical dataset, according to some exemplary systems, the mean value of the rewards for the state s′, that is Σ_{s̅∈\tilde{s}} r(s̅, a, s′)/n, is used as the reward value for r(s, a, s′) and n is the number of states in the set \tilde{s}.

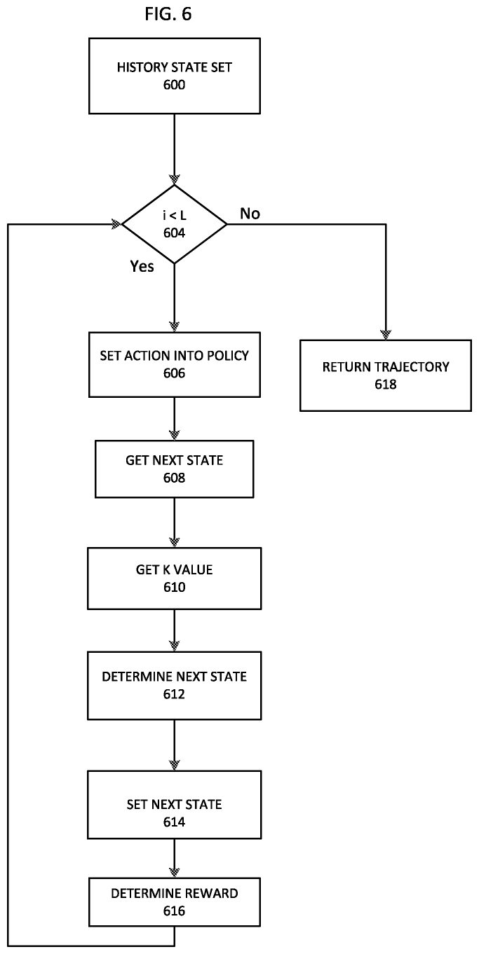

The complete process of obtaining a virtual trajectory from historical data can be seen in the routine shown in FIG. 6. A set of initial parameters is first obtained. The parameters include the history state set, Sₕᵢₛ where the state, S includes A, a set of actions, (a₀, a₁ . . . , aₙ); S, a set of states, s; and R, a set of rewards, r (600). The start parameters also including the start state, s₀, a trajectory length, L, the transition model T(s,a), the transition probability model, TP (s, a, s′), and initial incentive policy, π.

The routine then determines whether the state cycle, i, is less than the trajectory length, L (604). If the state set is not at the end of the trajectory length, the system sets the action of the period to the policy state aᵢ=π(sᵢ) 606). The routine then gets the next state as the input to the transition model, \tilde{s}ᵢ₊₁=T(sᵢ, aᵢ) (608). The routine gets the K value K N N (\tilde{s}ᵢ₊₁={sᵢ₊₁, 1, sᵢ₊₁, 2, . . . , s_{i+1,k}}, ∀s ∈K N N (\tilde{s}ᵢ₊₁), s ∈Sₕᵢₛ.) (610). Thus, the routine gest the K nearest and similar state for the state cycle, sᵢ, for all states. The next state, s*ᵢ₊₁, is set to the maximum of the output of the transition probability function, s*ᵢ₊₁=max_{s∈KNN(\tilde{s}}_{ᵢ₊₁₎} TP(sᵢ, aᵢ, s) (612). Thus, the next state is obtained by comparing all of the probability values of the transition probability model, TP, and selecting the largest probability value. The next state is set to the determined next state sᵢ₊₁=s*ᵢ₊₁ (614). The reward is then updated (616). The reward is updated for E if the historical data includes the rewards e.g. E₍ₛ_{ᵢ}_{,a}_{ᵢ₊₁}_{,s}_{ᵢ₊₁₎} ∈ U^{r(s}^{ᵢ}^{,a}^{ᵢ₊₁}^{,s}^{ᵢ₊₁}⁾ for (sᵢ, aᵢ₊₁, sᵢ₊₁,r(sᵢ, aᵢ₊₁, sᵢ₊₁)) ∈ U. Otherwise, the reward is set for E₍ₛ_{ᵢ}_{,a}_{ᵢ₊₁}_{,s}_{ᵢ₊₁₎} ∈ U^{r(s,a,s}^{ᵢ₊₁₎}. Thus, if the generated triple (sᵢ, aᵢ₊₁, sᵢ₊₁) exists in the historical trajectory, the historical reward for the resulting discount factor, r (sᵢ, aᵢ, sᵢ₊₁) may be used as the reward value, rᵢ₊₁. If the generated triple (sᵢ, aᵢ₊₁, sᵢ₊₁) does not exist in the historical data, the mean reward value of sᵢ₊₁ is used for the reward, rᵢ₊₁. After all of the rewards are determined for the historical data, the trajectory {s₀, a₀, s₁, r₁, a₁, . . . , S_{L}, r_{L}} is then returned (616).

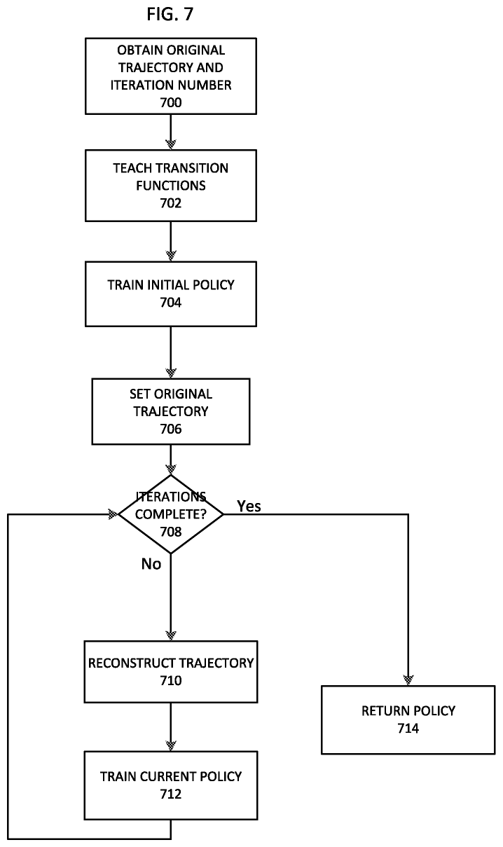

The total process of obtaining a policy update is shown in FIG. 7. The policy update needs to know the original trajectory dataset Trajₒ, as well as the number of iterations of the policy update (700). The original trajectory is initially broken up to obtain the transition functions, T and TP (702). According to the method shown in FIG. 5, the transition function (TF) and the transition probability function (TPF) may be trained via the broken up data. The transition function and the transition probability function are trained based on the original data, rather than trained through the reconstructed trajectory. The purpose of this is to make the transition between states closer to the real transition.

Then the Deep Q-Learning (DQN) method described above in FIG. 4 is used to train an initial policy, π⁰, based on the original trajectory (704). The initial trajectory is then set to the trajectory (706). The routine then determines whether the stop condition of total number of iterations has been reached (708).

Then in the i-th iteration, according to the existing policy, πⁱ⁻¹, transition function and transition probability function, the trajectory Trajᵢ may be reconstructed by the routine shown in FIG. 6 (710). Then the current round policy πⁱ is trained based on the current construction trajectory Trajᵢ (712). The iteration is then incremented and the routine loops back to step 708. The reconstruction process is repeated until the update stop condition is reached, and then the resulting policy, π^{N}, is returned (714), completing the policy update process. In this example, the stop condition may be when the set number of iterations is reached, or the change in policy is very small compared to a previous iteration.

After the policy update is completed, the coupon amount for individual users can be determined through the reinforcement learning policy. The budget allocation process also must choose the passenger for the incentive action. The example method considers selecting passengers with higher selection values to issue coupons, where the value is the sum of the GMVs of passengers from the initial day to the end of the optimization horizon. The V-value function is a value function only related to the state, s, which represents the expectation of the reward that the current state, s, can obtain. The higher the V value, the higher the GMV paid by the passenger. Here the original data is used for the V-value determination engine 208 to learn the V-values.

After determining the V-values from the V-value engine 208, passengers are sorted by V-value from highest to lowest. The updated policy 2r is then used to issue coupons to these passengers in turn starting from the highest valued passengers until the budget is exhausted.

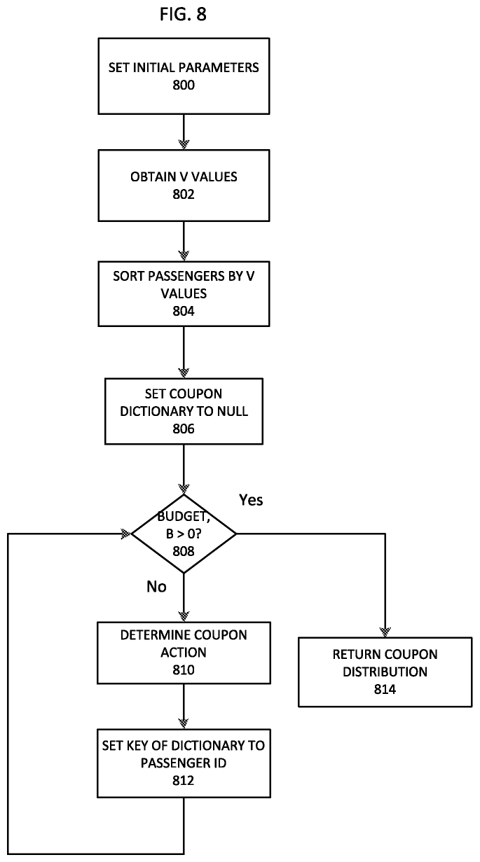

The framework of the budget allocation process is shown in the routine in FIG. 8. The initial parameters of an action set, A=(a₀, a₁ . . . aₙ), a value function V, a people state set, S_{now}, a budget, B and a policy, π, are obtained (800). The action set A represents the types of coupons that can be issued. The set A is set as a discrete value that is determined by statistical analysis of historical data of coupons, redemption rate, and value. The V-value function is trained from the original data set Dₒ. The neural network is used as the V-valued function. The V-valued function is the expected total revenue that a passenger would contribute over a given horizon when he or she is aₜ a particular state. S_{now} is the state of all passengers, B represents the budget for the day, and π represents the updated policy. Thus, a deep-Q learning network (DQN) that is pre-trained is updated as explained in the policy update step 314 of FIG. 3. The updated DQN generates the optimal action for each passenger.

First, the V-value function is trained based on the original data Dₒ, and then the V-value is predicted for all current users according to the V-value function (802). Thus, for state, s ∈ S_{now}, the routine gets the V value of V(s) and gets the total V value set to V(S_{now}).

The second step of the process is to arrange the V values in descending order to get Vₛₒᵣₜ, and then arrange the corresponding states according to their V values to get the state of all passengers Sₛₒᵣₜ (804). Thus, the set V(S_{now}) is sorted by descending order. The sorted values, Vₛₒᵣₜ is obtained by getting the corresponding Sₛₒᵣₜ, ∀i, Vₛₒᵣₜ[i]=V (Sₛₒᵣₜ[i]). After the sorting, the coupon dictionary D_{coupon} is set to null, j=0 (806). The routine then determines whether the budget, B is larger than zero (808).

As long as the budget, B, is larger than zero, the routine uses the policy to determine the action of which type of coupon to send and subtracts the cost of the coupon from the budget (810). Thus, each action is determined by a=π (Sₛₒᵣₜ[j]), B=B−cost (a). The key of the dictionary D_{coupon} is set to the ID of the passenger, and then the amount of the coupon for each ID is stored (812). Then, according to the people after the ordering, coupons are issued according to the trained policy π in turn until the budget is consumed, and the coupon ID and the amount of coupons are stored in D_{coupon}. This process is repeated until the budget is exhausted (808). Then the dictionary, D_{coupon}, is returned to get a complete one-day coupon specific solution (814).

The effectiveness and efficiency of the example MDP model was demonstrated by conducting an online experiment across a large number of cities using the example incentive determination system. The passengers in the experiment were ones who finished the first order within 30 days. In this example, the number of passengers was 466,495. The passengers were partitioned into three groups, a control group, a baseline method group and an MDP model group on average. The time of online experiment was for 21 days. The metrics of the experiment are summarized as follows:

$$Delta GMV percentage = \frac{G M {V}_{method} - G M {V}_{control}}{G M {V}_{control}} \\ Delta Retain percentage = \frac{Retained {User}_{method} - Retained {User}_{control}}{Retained {User}_{control}} \\ ROI = \frac{G M {V}_{method} - G M {V}_{control}}{{Cost}_{method} - {Cost}_{control}}$$

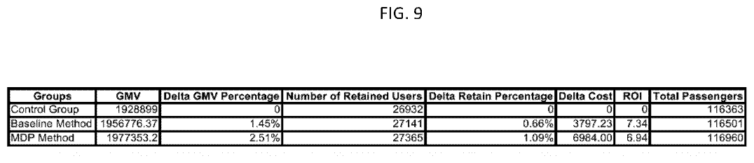

The online experiment result of 21 days may be shown in the following table shown in FIG. 9. As may be seen from the table in FIG. 9, the GMV in the MDP method group shows the number of retained users performed better than that of the operation team group. When comparing with the operation team group, the GMV increased by 2.51%, and the number of orders increased by 1.09% for the MDP group.

The techniques described herein are implemented by one or more special-purpose computing devices. The special-purpose computing devices may be desktop computer systems, server computer systems, portable computer systems, handheld devices, networking devices or any other device or combination of devices that incorporate hard-wired and/or program logic to implement the techniques. Computing device(s) are generally controlled and coordinated by operating system software. Conventional operating systems control and schedule computer processes for execution, perform memory management, provide file system, networking, I/O services, and provide a user interface functionality, such as a graphical user interface (“GUI”), among other things.

FIG. 10 is a block diagram that illustrates a computer system 1000 upon which any of the embodiments described herein may be implemented. The system 1000 may correspond to the client devices 102 or the transportation devices 112 described above. The computer system 1000 includes a bus 1002 or other communication mechanism for communicating information, one or more hardware processors 1004 coupled with bus 1002 for processing information. Hardware processor(s) 1004 may be, for example, one or more general purpose microprocessors.

The computer system 1000 also includes a main memory 1006, such as a random access memory (RAM), cache and/or other dynamic storage devices, coupled to bus 1002 for storing information and instructions to be executed by processor 1004. Main memory 1006 also may be used for storing temporary variables or other intermediate information during execution of instructions to be executed by processor 1004. Such instructions, when stored in storage media accessible to processor 1004, render computer system 1000 into a special-purpose machine that is customized to perform the operations specified in the instructions. The computer system 1000 further includes a read only memory (ROM) 1008 or other static storage device coupled to bus 1002 for storing static information and instructions for processor 1004. A storage device 1010, such as a magnetic disk, optical disk, or USB thumb drive (Flash drive), etc., is provided and coupled to bus 1002 for storing information and instructions.

The computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the operations, methods, and processes described herein are performed by computer system 1000 in response to processor(s) 1004 executing one or more sequences of one or more instructions contained in main memory 1006. Such instructions may be read into main memory 1006 from another storage medium, such as storage device 1010. Execution of the sequences of instructions contained in main memory 1006 causes processor(s) 1004 to perform the process steps described herein. In alternative embodiments, hard-wired circuitry may be used in place of or in combination with software instructions.

The main memory 1006, the ROM 1008, and/or the storage 1010 may include non-transitory storage media. The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1010. Volatile media includes dynamic memory, such as main memory 1006. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

The computer system 1000 also includes a network interface 1018 coupled to bus 1002. Network interface 1018 provides a two-way data communication coupling to one or more network links that are connected to one or more local networks. For example, network interface 1018 may be an integrated services digital network (ISDN) card, cable modem, satellite modem, or a modem to provide a data communication connection to a corresponding type of telephone line. As another example, network interface 1018 may be a local area network (LAN) card to provide a data communication connection to a compatible LAN (or WAN component to communicated with a WAN). Wireless links may also be implemented. In any such implementation, network interface 1018 sends and receives electrical, electromagnetic or optical signals that carry digital data streams representing various types of information.

The computer system 1000 can send messages and receive data, including program code, through the network(s), network link and network interface 1018. In the Internet example, a server might transmit a requested code for an application program through the Internet, the ISP, the local network and the network interface 1018.

The received code may be executed by processor 1004 as it is received, and/or stored in storage device 1010, or other non-volatile storage for later execution.

Each of the processes, methods, and routines described in the preceding sections may be embodied in, and fully or partially automated by, code modules executed by one or more computer systems or computer processors comprising computer hardware. The processes and methods may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The exemplary blocks or states may be performed in serial, in parallel, or in some other manner. Blocks or states may be added to or removed from the disclosed exemplary embodiments. The exemplary systems and components described herein may be configured differently than described. For example, elements may be added to, removed from, or rearranged compared to the disclosed exemplary embodiments.

The various operations of exemplary methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function, but can learn from training data to make a predictions model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some exemplary embodiments, the processors or processor-implemented engines may be located in a single geographic location (e.g., within a home environment, an office environment, or a server farm). In other exemplary embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific exemplary embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, the term “or” may be construed in either an inclusive or exclusive sense. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the exemplary configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A transportation hailing system, comprising:
a plurality of client devices, each of the client devices in communication with a network and executing an application to request a transportation hailing service, each of the client devices associated with one of a plurality of passengers;
a plurality of transportation devices, each of the transportation devices executing an application displaying information to provide transportation to respond to a request for the transportation hailing service;
a database storing state data and action data received from the plurality of client devices and the plurality of transportation devices, the state data associated with the utilization of the transportation hailing service and the action data associated with a plurality of incentive actions for each passenger, each incentive action associated with a different incentive to a passenger to engage the transportation hailing service;
an incentive system coupled to the plurality of transportation devices and client devices via the network, the incentive system including:
a Q-value neural network trained to determine rewards associated with incentive actions from a set of virtual trajectories of states, incentive actions, and rewards, based on a history of the action data and associated state data;
a V-value neural network operable to determine a V-value from the use of the transportation service for each of the plurality of passengers via;
an incentive policy engine operable to order the plurality of passengers according to the associated V-values and determine an incentive policy including selected incentive actions from the plurality of incentive actions based on the determined rewards for each of the plurality of passengers; and
an incentive server operable to communicate a selected incentive to at least some of the client devices according to the determined incentive policy via the network.

2. The transportation hailing system of claim 1, wherein each of the plurality of incentive actions is assigned a value, and wherein the communicating of the selected incentives continues to the some of the client devices until an overall budget is exceeded by the value of the communicated selective incentive actions.

3. The transportation hailing system of claim 1, wherein the inventive system determines the virtual trajectories by being configured to:
train a transition function to determine a next state from each incentive action by breaking initial trajectories of actions, states and rewards;
determine a next state via the trained transition function;
determine whether the next state from the incentive action matches the next state in the historical trajectory;
assign a historical reward to the next state if the next state matches; and
determine a reward matching a reward associated with a neighbor next state in the historical trajectory of the next state does not match.

4. The transportation hailing system of claim 3, wherein the historical reward is the average of all rewards associated with the state in the historical trajectory.

5. The transportation hailing system of claim 1, wherein the plurality of incentive actions are coupons offering different discount values for engaging the transportation hailing service.

6. The transportation hailing system of claim 1, wherein the V-value is the sum of payments of a passenger over a pre-determined period for using the transportation hailing service.

7. The transportation hailing system of claim 1, wherein the incentives are communicated to the client devices over the network.

8. The transportation hailing system of claim 1, wherein the incentive system is further operable to update the incentive policy by repeating the training the Q-value neural network, determining a V-value, ordering the plurality of passengers, for additional state and action data received from the client devices and transportation devices after a pre-determined cycle period.

9. A method of determining the distribution of incentives to use a transportation hailing system including a plurality of client devices, each of the client devices in communication with a network and executing an application to request a transportation hailing service, each of the client devices associated with one of a plurality of passengers and a plurality of transportation devices, each of the transportation devices executing an application displaying information to provide transportation to respond to a request for the transportation hailing service, the method comprising:
storing state data and action data received from the plurality of client devices and the plurality of transportation devices for each passenger in a database, the state data associated with the utilization of the transportation hailing service and the action data associated with a plurality of incentive actions, each incentive action associated with a different incentive to a passenger to engage the transportation hailing service;
training a Q-value neural network to determine rewards associated with actions from a set of virtual trajectories of states, incentive actions, and rewards, based on a history of the action data and associated state data from the database;
determining a V-value from the use of the transportation service for each of the plurality of passengers via a V-value neural network;
ordering the plurality of passengers according to the associated V-values via an incentive policy engine;
determining an incentive policy including selected incentive actions from the plurality of incentive actions based on the determined rewards via the incentive policy engine; and
communicating a selected incentive to at least some of the client devices via an incentive server according to the determined incentive policy.

10. The method of claim 9, wherein each of the plurality of incentive actions is assigned a value, and wherein the communicating of the selected incentives continues to the some of the client devices until an overall budget is exceeded by the value of the communicated selective incentive actions.

11. The method of claim 9, further comprising determining the virtual trajectories by:
training a transition function to determine a next state from each incentive action by breaking initial trajectories of actions, states and rewards;
determining a next state via the trained transition function;
determining whether the next state from the incentive action matches the next state in the historical trajectory;
assigning a historical reward to the next state if the next state matches; and
determining a reward matching a reward associated with a neighbor next state in the historical trajectory of the next state does not match.

12. The method of claim 11, wherein the historical reward is the average of all rewards associated with the state in the historical trajectory.

13. The method of claim 9, wherein the plurality of incentive actions are coupons offering different discount values for engaging the transportation hailing service.

14. The method of claim 9, wherein the V-value is the sum of payments of a passenger over a pre-determined period for using the transportation hailing service.

15. The method of claim 9, wherein the incentives are communicated to the client devices over a network.

16. The method of claim 9, further comprising updating the incentive policy by repeating the training the Q-value neural network, determining a V-value, ordering the plurality of passengers, for additional state and action data received from the client devices and transportation devices after a pre-determined cycle period.

17. An incentive distribution system comprising:
a database storing state data and action data received from a plurality of client devices and a plurality of transportation devices, the state data associated with the utilization of a transportation hailing service by a plurality of passengers associated with one of the client devices and the action data associated with a plurality of incentive actions, each incentive action associated with a different incentive to a passenger to engage the transportation hailing service;
a Q-value determination engine that is trained to determine rewards associated with incentive actions from a set of virtual trajectories of states, incentive actions, and rewards, based on a history of the action data and associated state data from the database;
a V-value engine operable to determine a V-value from the use of the transportation service for each of the plurality of passengers;
an incentive policy determination engine operable to:
order the plurality of passengers according to the associated V-values; and
determine an incentive policy including selected incentive actions from the plurality of incentive actions based on the determined rewards for each of the plurality of passengers; and
an incentive server, operable to communicate a selected incentive to at least some of the client devices according to the determined incentive policy.
